(19) United States
(12) Patent Application Publication
(10) Pub. No.: US 2026/0218797 A1
(43) Pub. Date: Jul. 30, 2026

(54) FLUID CONTROL VALVE

(71) Applicant: CKD CORPORATION, Komaki-shi, Aichi (JP)

(72) Inventor: Junichi BITO, Komaki-shi (JP)

(73) Assignee: CKD CORPORATION, Komaki-shi, Aichi (JP)

(21) Appl. No.: 19/148,398

(22) PCT Filed: Mar. 21, 2024
(86) PCT No.: PCT/JP2024/010962

§ 371 Date: Jul. 16, 2025

(30) Foreign Application Priority Data
Jun. 28, 2023 (JP) 2023-105753

(51) Int. Cl. F16K 7/12

(52) U.S. Cl. CPC F16K 7/12

(57) ABSTRACT

A diaphragm member is formed in a spherical cap shape that is centered on an extension line of a central axis of an operation rod and bulges toward the operation rod. The diaphragm member is held, at its vertex, from both sides in a direction parallel to the central axis, between a first holding piece contacting the diaphragm member from the operation rod side and a second holding piece contacting the diaphragm member from the valve element side. The first and second holding pieces each has a circular shape positioned coaxially with the operation rod. The diameter of the first holding piece is larger than the diameter of the second holding piece. A surface of the first holding piece facing the diaphragm member is a convex spherical surface bulging toward the diaphragm member and having the center on the central axis of the operation rod.

### TECHNICAL FIELD

The invention relates to a fluid control valve including an operation rod, a valve element connected to the operation rod, a valve seat that the valve element contacts with and separates from, and a diaphragm located between the operation rod and the valve element, the fluid control valve being configured to control a control fluid by causing the valve element driven by the operation rod to contact with and separate from the valve seat in a direction of the central axis of the operation rod.

### BACKGROUND ART

For a film forming process in a semiconductor manufacturing process, several types of process gases are used. A fluid control valve is used to control the flow rate of the process gases. As the fluid control valve, for example, fluid control valves disclosed in Patent Document 1 and Patent Document 2 have been known. The fluid control valve disclosed in Patent Document 1 is an air-operated on-off valve, which is configured to control the flow rate of a process gas by causing a diaphragm member to contact with or separate from a valve seat.

More specifically, a stem (i.e., a diaphragm presser) is in contact with the vertex portion of a diaphragm member formed in a spherical cap or dome shape. The diaphragm member is pressed by the stem by operation of an actuator, and deformed to come into contact with the valve seat. The state where the diaphragm member is in contact with the valve seat is a valve-closed state of the fluid control valve. Then, when the diaphragm member is released from the pressure of the stem, the diaphragm member returns to its original spherical cap shape by self-returning force, separating from the valve seat. This state where the diaphragm member is separated from the valve seat is a valve-open state of the fluid control valve.

### RELATED ART DOCUMENTS

### Patent Documents

Patent Document 1: JP 2016-180490A
Patent document 2: JP 2017-223318A

### SUMMARY OF INVENTION

### Problems to be Solved by the Invention

However, the process gas used in the atomic layer deposition method (ALD), which is a film-forming technique that has been widely used, has high temperatures (about 200° C.), and thus the self-returning force of the diaphragm member may decrease under such high temperatures. This may make it impossible for the diaphragm member to completely return to its original spherical cap shape when the fluid control valve is changed from the valve-closed state to the valve-open state. If the diaphragm member fails to completely return to its original spherical cap shape, the distance between the diaphragm member and the valve seat in the valve-open state decreases, which may result in a decrease in Cv value. In order to perform the film-forming process for semiconductors in the shortest time possible to improve productivity, the fluid control valve has been demanded to have higher Cv values, that is, to increase the amount of gas that can flow at once. In such circumstances, the decrease in Cv value due to the deteriorated self-returning force of the diaphragm member as mentioned above is undesirable.

Therefore, the inventor of the invention conceived the use of a fluid control valve 100 shown in FIG. 5, for example, as a countermeasure against the decrease in self-returning force of the diaphragm member under high temperatures.

The fluid control valve 100 includes an actuator unit 4. This actuator unit 4 includes an air cylinder 6, which is operated pneumatically. In the air cylinder 6, a piston (not shown) is installed to be slidable in the vertical direction in FIG. 5. When the piston moves up and down, an operation rod 11 is moved up and down. Furthermore, the distal end of the operation rod 11 is connected to a valve element 32 that contacts with or separates from a valve seat 33 according to the vertical motion of the operation rod 11. A diaphragm member 34 has a circular disk shape and an outer circumferential part thereof is clamped and fixed in the fluid control valve 100, and a central portion thereof is held, or clamped, from above and below in FIG. 5 by a holding portion 111 of the operation rod 11 and the valve element 32.

In the thus configured fluid control valve 100, the diaphragm member 34 is deformed as shown in FIGS. 6A to 6C as the valve element 32 moves to contact with or separation with respect to the valve seat 33. FIG. 6A is a view showing a state of the diaphragm member 34 while the fluid control valve 100 shown in FIG. 5 is in a valve-open state. FIG. 6B is a view showing a deformed state of the diaphragm member 34 just after the valve element 32 of the fluid control valve 100 starts moving in a contact direction. FIG. 6C is a view showing a deformed state of the diaphragm member 34 while the fluid control valve 100 shown in FIG. 5 is in a valve-closed state.

When the fluid control valve 100 is in the valve-open state, the diaphragm member 34 is in an almost natural state, not deformed (FIG. 6A). As the operation rod 11 is driven in the contact direction, bringing the valve element 32 into contact with the valve seat 33, the diaphragm member 34 gradually deforms such that its central portion, clamped between the operation rod 11 (the holding portion 111) and the valve element 32, is pushed down toward the valve seat 33 (see FIG. 5) (FIG. 6B). When the valve element 32 then contacts with the valve seat 33, that is, when the fluid control valve 100 comes to the valve-closed state, the diaphragm member 34 is most deformed (FIG. 6C).

To change from the valve-closed state to the valve-closed state, the operation rod 11 is driven upward in the figures. Thus, the operation rod 11 and the valve element 32 move in the same direction, separating the valve element 32 from the valve seat 33, and the fluid control valve 100 comes to the valve-open state. At that time, the diaphragm member 34 is held between the operation rod 11 (the holding portion 111) and the valve element 32, and the central portion is pulled up in a direction to separate the central portion from the valve seat 33. Thus, the diaphragm member 34 can reliably return to the original shape as shown in FIG. 6A. This can therefore reduce the possibility that the diaphragm member 34 could not return to the original shape even under a high-temperature environment, for example, in a case where a high-temperature process gas is used as a control fluid.

However, the above-described fluid control valve 100 has the following problems. During deformation of the diaphragm member 34 as shown in FIG. 6A to 6C, the inventor of the present application found out that the stress concentrates on a clamped portion P21 of the diaphragm member 34. When the stress concentration always occurs on the same site of the diaphragm member 34, the diaphragm member 34 may break at that portion P21 subjected the stress concentration when the valve element 32 repeatedly contacts with and separates from the valve seat 33 in the fluid control valve 100.

In recent years, fluid control valves have been demanded to provide high Cv values and accordingly increase the distance (the stroke amount) between the position of the valve element in the valve-open state and the position in the valve-closed state of the valve element than before. However, such an increased stroke amount leads to a large deformation amount of the diaphragm member. Because of the large deformation amount, the diaphragm member 34 is more likely to break at the foregoing portion P21 subjected to the stress concentration. This stress concentration occurring in the diaphragm member 34 is a factor preventing an increase in the stroke amount.

The present invention has been made to address the above problems and has a purpose to provide a fluid control valve configured to increase a stroke amount.

### Means of Solving the Problems

To achieve the above-mentioned purpose, a fluid control valve, which is one aspect of the present invention, is configured as below.

(1) In a fluid control valve comprising: an operation rod; a valve element coupled to the operation rod; a valve seat which the valve element makes contact with and separation from; and a diaphragm member located between the operation rod and the valve element, the valve element being to be driven by the operation rod to make the contact with and separation in a direction of a central axis of the operation rod to control a control fluid, the diaphragm member has a spherical cap shape that is centered on an extension line of the central axis and bulges toward the operation rod, and the diaphragm member is held, at its vertex portion, from both sides in a direction parallel to the central axis by a first holding piece that contacts the diaphragm member from a side of the operation rod and a second holding piece that contacts the diaphragm member from a side of the valve element, the first holding piece and the second holding piece each have a circular shape located coaxially with the operation rod, and a diameter of the first holding piece is larger than a diameter of the second holding piece, and a surface of the first holding piece, facing the diaphragm member, is a convex spherical surface that bulges toward the diaphragm member and is centered on the central axis.

(2) In the fluid control valve described in (1), preferably, a radius of the convex spherical surface, which is a first radius, is smaller than a radius of a spherical surface of the diaphragm member facing the convex spherical surface, which is a second radius.

(3) In the fluid control valve described in (2), preferably, the first radius is 50% or more and 65% less of the second radius.

(4) In the fluid control valve described in any one of (1) to (3), preferably, the diameter of the first holding piece is a value exceeding 35% of a diameter of the diaphragm member when projected onto a plane perpendicular to the central axis.

According to the foregoing fluid control valve, when the valve element moves to contact the valve seat, the diaphragm member gradually deforms such that its vertex portion clamped between the first and second holding pieces is pushed down toward the valve seat. During this deformation, the diaphragm member deforms to follow the convex spherical surface of the first holding piece. Thus, the contact range where the diaphragm member contacts the convex spherical surface gradually widens from the central portion toward the outer circumferential side of the diaphragm member as the valve element comes closer to the valve seat. At that time, the stress on the diaphragm member concentrates at the outermost circumferential portion of the contact range in the diaphragm member, which was confirmed by the inventor of the present application by the finite element analysis. In other words, when changing from the valve-open state to the valve-closed state, the site of stress concentration in the diaphragm member shifts according to changes of the contact range, without being fixed. This prevents the diaphragm member from breaking even when the valve element repeats contact and separation motions. Since the diaphragm member is unlikely to break as above, the distance (the stroke amount) between the position of the valve element in the valve-open state and the position of the same in the valve-closed state can be increased than before. Such an increased stroke amount allows an increase in the distance between the valve element and the valve seat in the valve-open state, and hence the Cv value of the fluid control valve increases.

### Effects of the Invention

The fluid control valve of the invention can increase the stroke amount.

### BRIEF DESCRIPTION OF THE DRAWINGS

FIG. 1 is a cross-sectional view of a fluid control valve in an embodiment.

FIG. 2 is a partial enlarged view of a part A in FIG. 1.

FIG. 3 is a perspective view of a diaphragm member.

FIG. 4A is a view showing a state of the diaphragm member while the fluid control valve is in a valve-open state in the embodiment.

FIG. 4B is a view showing a deformed state of the diaphragm member just after a valve element of the fluid control valve starts moving in a contact direction in the embodiment.

FIG. 4C is a view showing a deformed state of the diaphragm member while the fluid control valve is in the valve-closed state in the embodiment.

FIG. 5 is a cross-sectional view of a fluid control valve, which was invented by the inventor of the present application as a countermeasure against the problems that the self-returning force of the diaphragm member deteriorates under high temperatures.

FIG. 6A is a view showing a state of the diaphragm member while the fluid control valve shown in FIG. 5 is in the valve-open state.

FIG. 6B is a view showing a deformed state of the diaphragm member just after the valve element of the fluid control valve shown in FIG. 5 starts moving in the contact direction.

FIG. 6C is a view showing a deformed state of the diaphragm member while the fluid control valve shown in FIG. 5 is in the valve-closed state.

FIG. 7 is a graph showing the relationship between the moving amount of the valve element in the contact direction from a position in the valve-open state and the stress occurring in the diaphragm member.

FIG. 8 is a graph showing the relationship between the stroke amount and the Cv value under high-temperatures of the valve element.

### MODE FOR CARRYING OUT THE INVENTION

An embodiment of a fluid control valve according to the invention will now be described referring to the accompanying drawings. The figures used herein are simplified diagrams, which do not illustrate the exact shapes, sizes, etc.

### (Configuration of Fluid Control Valve)

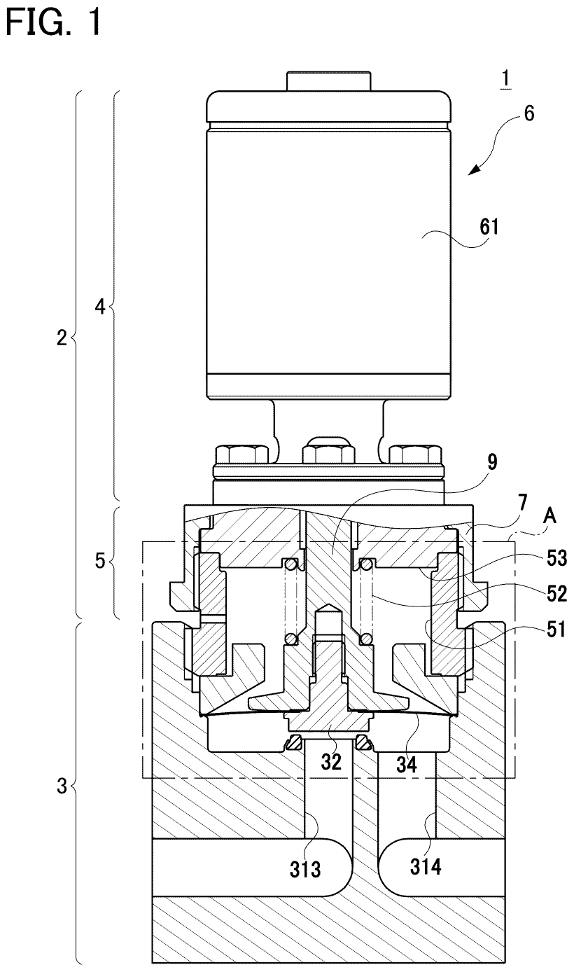

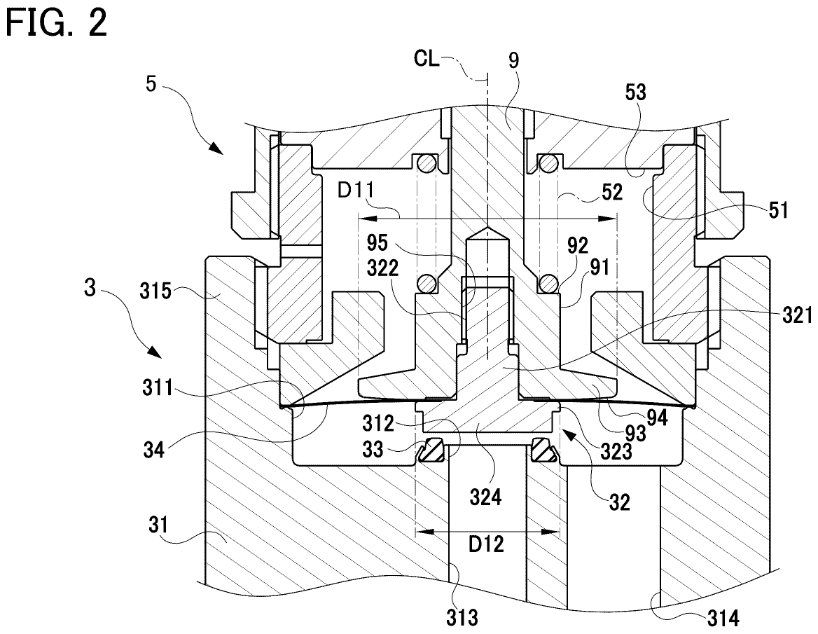

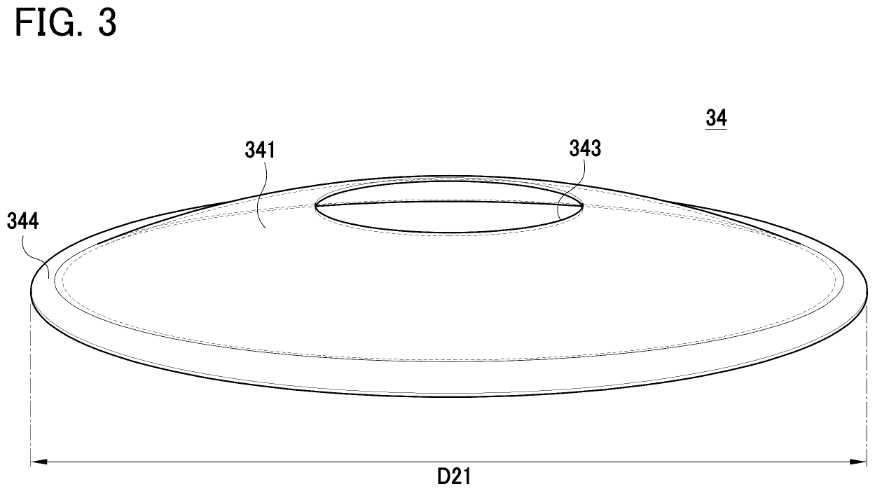

The configuration of a fluid control valve 1 in the present embodiment will be described with reference to the drawings. FIG. 1 is a cross-sectional view of the fluid control valve 1 in the present embodiment. FIG. 2 is a partially enlarged view of a part A in FIG. 1. FIG. 3 is a perspective view of a diaphragm member 34.

The fluid control valve 1 is a pneumatically-driven gas valve to be installed in a gas supply system of a semiconductor manufacturing apparatus, and includes a drive unit 2 and a valve unit 3 as shown in FIG. 1. Further, the drive unit 2 includes an actuator unit 4 and a spring unit 5.

The actuator unit 4 will be described first. This actuator unit 4 is provided with a pneumatically-driven air cylinder 6 and a joint bracket 7 for connecting the air cylinder 6 to the spring unit 5.

The air cylinder 6 is provided with a cylindrical case 61, a piston (not shown) installed in the case 61, and a columnar drive shaft (not shown) connected to the piston. The piston is slidable in the case 61 in the vertical direction in FIG. 1.

The vertical motion of the piston causes the drive shaft to move forward or backward in the axial direction of the drive shaft. The axial direction of the drive shaft is parallel to the vertical direction in FIG. 1 and coincides with the contact and separation direction of a valve element 32 with respect to a valve seat 33, which will be mentioned later. In the figure, the separation direction is upward and the contact direction is downward.

The distal end portion of the drive shaft of the air cylinder 6, located in the valve unit 3, protrudes from the case 61 and is coupled to an operation rod 9 that is columnar and located coaxially with the drive shaft. Thus, as the drive shaft of the air cylinder 6 moves forward and backward, the operation rod 9 also moves forward and backward along its central axis CL (see FIG. 2).

The operation rod 9 is inserted through the spring unit 5 and extends from the inside of the joint bracket 7 into the valve unit 3. A part of the operation rod 9 inserted in the valve unit 3 includes a large diameter portion 91 having a larger diameter than other parts of the operation rod 9 inserted through the joint bracket 7 and extending in the spring unit 5, as shown in FIG. 2. This large diameter portion 91 forms a shoulder portion 92. Furthermore, the operation rod 9 includes a first holding piece 93 at the end opposite the shoulder portion 92 of the large diameter portion 91. The first holding piece 93 is used to hold, or clamp, a diaphragm member 34 mentioned later, in cooperation with a second holding piece 323 mentioned later. The first holding piece 93 has a circular shape with a radius in a direction perpendicular to the central axis CL of the operation rod 9 and is located coaxially with the central axis CL. The diameter D11 of the first holding piece 93 is set larger than the diameter of the large diameter portion 91. The surface of the first holding piece 93 facing the diaphragm member 34 is a convex spherical surface 94 bulging, or protruding, toward the diaphragm member 34. The convex spherical surface 94 is centered on the central axis CL of the operation rod 9, and has a radius (a first radius) set to, for example, about 70 mm. The outer peripheral edge of the convex spherical surface 94 is rounded by chamfering.

The operation rod 9 has an internally-treaded portion 95 formed in the end face on the valve unit 3 side so that the valve element 32 mentioned later can threadedly engage therein.

The spring unit 5 is described below. This spring unit 5 is provided with a compression spring 52 positioned coaxially with the operation rod 9 inside an internal space 51. The compression spring 52 is compressed by an end face 53 facing the internal space 51 on the actuator unit 4 side and the shoulder portion 92 of the operation rod 9. Therefore, the compression spring 52 always urges the operation rod 9 in the contact direction (downward in the figure).

The valve unit 3 is described below. This valve unit 3 is provided with a body 31, the valve element 32, the valve seat 33, and the diaphragm member 34. The body 31 includes a cylindrical portion 315 connected to the spring unit 5. The body 31 has a valve chamber 311 formed by drilling in the cylindrical portion 315.

The valve chamber 311 has a valve port 312 at the center of the bottom, through which the valve chamber 311 communicates with an input passage 313. This input passage 313 is used to input a process gas into the valve chamber 311. Further, on the bottom surface of the valve chamber 311, the annular valve seat 33 is fixed on the outer circumferential side of the valve port 312 and coaxially with the valve port 312. This valve seat 33 is made of, for example, PI (polyimide) or PFA (tetrafluoroethylene perfluoroalkyl vinyl ether copolymer), which has excellent heat resistance. The valve chamber 311 further communicates with an output passage 314 outside the valve seat 33 in the radial direction of. This output passage 314 is used to output the process gas from the valve chamber 311.

The valve element 32 is made of, for example, stainless steel. The valve element 32 includes a main body portion 321 having a circular columnar shape, and further an externally-threaded portion 322 on the side corresponding to the operation rod 9 of the main body portion 321. The externally-threaded portion 322 threadedly engages the internally-threaded portion 95 of the operation rod 9 to couple the valve element 32 to the operation rod 9.

The valve element 32 is provided with the second holding piece 323 on the side opposite from the externally-threaded portion 322 of the main body portion 321. The second holding piece 323 has a circular shape with a radius in the direction perpendicular to the central axis CL of the operation rod 9 and is located coaxially with the central axis CL. The diameter D12 of the second holding piece 323 is smaller than the diameter D11 of the first holding piece 93. Since the valve element 32 is coupled to the operation rod 9, the second holding piece 323, together with the first holding piece 93, holds, or clamps, the diaphragm member 34 from above and below in FIG. 2. The surface of the second holding piece 323 facing the diaphragm member 34 is a flat surface having an outer peripheral edge rounded by chamfering.

The valve element 32 is provided with a contact portion 324 on the side opposite from the main body portion 321 of the second holding piece 323, so that the contact portion 324 comes into contact with and separates from the valve seat 33. This contact portion 324 also has a circular shape coaxial with the central axis CL of the operation rod 9. Since the valve element 32 is coupled to the operation rod 9, the contact portion 324 moves to contact or separate from the valve seat 33 in the direction of the central axis CL as the operation rod 9 moves forward or backward.

The diaphragm member 34 is made of, for example, Ni alloy. The diaphragm member 34 has a spherical cap or dome shape that is centered on an extension line of the central axis CL and bulges toward the operation rod 9. Thus, a facing surface 341 of the diaphragm member 34, which faces the convex spherical surface 94, is a spherical surface. The facing surface 341 has a spherical radius (a second radius) set to, for example, about 140 mm. The back side of the facing surface 341 is referred to as a back surface 342. The vertex portion of the diaphragm member 34 (the facing surface 341) is provided with a cut edge 343. This cut edge 343 has a circular shape with a radius in a direction perpendicular to the central axis CL and located coaxially with the central axis CL. The facing surface 341 includes, as its outer circumferential portion, a rim portion 344 that is flat perpendicular to the central axis CL. This rim portion 344 has a circular shape with a radius in the direction perpendicular to the central axis CL.

The diaphragm member 34 configured as above is fixed inside the fluid control valve 1 as below. The externally-threaded portion 322 of the valve element 32 is inserted in the cut edge 343 of the diaphragm member 34 from the opposite side from the facing surface 341, and the diaphragm member 34 and the valve element 32 are positioned to be coaxial with each other, with the back surface 342 of the diaphragm member 34 in contact with the second holding piece 323 of the valve element 32. Then, the externally-threaded portion 322 is threaded into the internally-threaded portion 95 of the operation rod 9 until the convex spherical surface 94 of the first holding piece 93 contacts the spherical surface 341 of the diaphragm member 34. In this way, the diaphragm member 34 is held, or clamped, at an edge portion around the cut edge 343 from both sides in the direction of the central axis CL (the vertical direction in the figure) by the first holding piece 93 and the second holding piece 323 as shown in FIG. 1 or FIG. 2. That is, the operation rod 9 and the diaphragm member 34 are joined together. Further, the rim portion 344 of the diaphragm member 34 is fixedly sandwiched from above and below in the valve unit 3 as shown in FIG. 1 or FIG. 2. The diaphragm member 34 thus fixed inside the fluid control valve 1 partitions the inside of the cylindrical portion 315 of the body 31 into the valve chamber 311 and an upper part thereof, and repeats elastic deformation in association with movement of the valve element 32 in the contact and separation direction.

### (Operations of Fluid Control Valve)

The operations for changing the fluid control valve 1 from a valve-open state to a valve-closed state will be described. When operation air is supplied to the air cylinder 6, the fluid control valve 1 comes into the valve-open state as shown in FIG. 1. Since the operation rod 9 is always urged by the compression spring 52 in the contact direction as mentioned above, the valve-open state is a state where the actuator unit 4 lifts the operation rod 9 upward in the figure against the urging force of the compression spring 52. To change from this state to the valve-closed state, the supply of the operation air to the air cylinder 6 is stopped. Then, the operation rod 9 and the valve element 32 are pushed down toward the valve seat 33 by the urging force of the compression spring 52, bringing the contact portion 324 of the valve element 32 into contact with the valve seat 33.

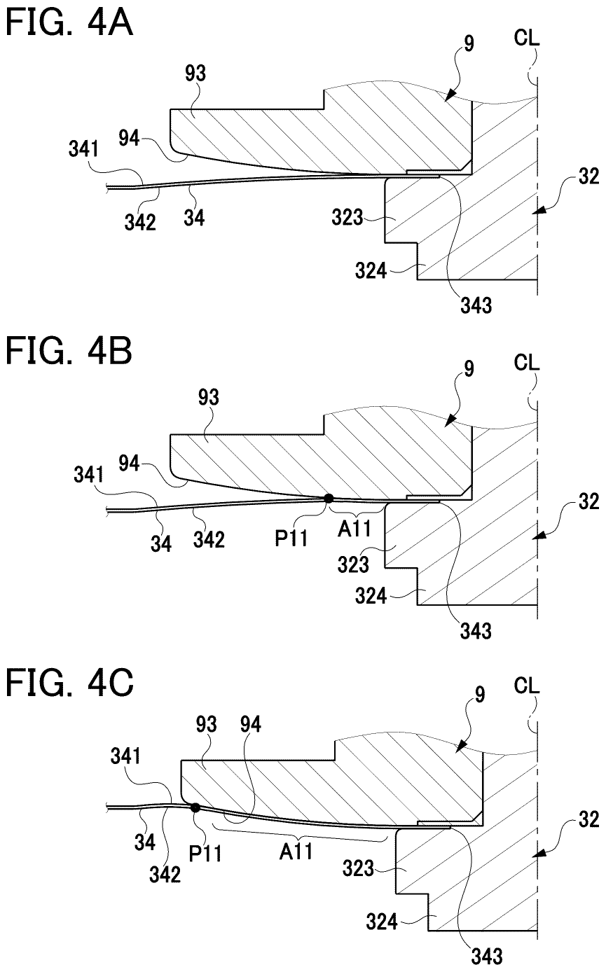

Next, deformation of the diaphragm member 34, caused in the process of changing from the valve-open state to the valve-closed state as above, will be described referring to FIGS. 4A to 4C. FIG. 4A is a view showing a state of the diaphragm member 34 while the fluid control valve 1 is in the valve-open state in the embodiment. FIG. 4B is a view showing a deformed state of the diaphragm member 34 just after the valve element 32 of the fluid control valve 1 in the embodiment starts moving in the contact direction. FIG. 4C is a view showing a deformed state of the diaphragm member 34 while the fluid control valve 1 in the embodiment is in the valve-closed state.

When the fluid control valve 1 is in the valve-open state, the diaphragm member 34 is in an almost natural state without deformation (FIG. 4A). As the operation rod 9 is driven in the contact direction, bringing the valve element 32 into contact with the valve seat 33, the diaphragm member 34 gradually deforms such that its central portion, which is clamped between the first holding piece 93 and the second holding piece 323, is pushed down toward the valve seat 33 (see FIG. 2) (FIG. 4B). When the valve element 32 then contacts with the valve seat 33, that is, when the fluid control valve 1 comes to the valve-closed state, the diaphragm member 34 is most deformed. (FIG. 4C). During this deformation, the diaphragm member 34 deforms to follow the shape of the convex spherical surface 94, so that the contact range All where the convex spherical surface 94 of the first holding piece 93 and the facing surface 341 of the diaphragm member 34 contact with each other gradually widen from the central portion toward the outer circumferential side as the valve element 32 comes closer to the valve seat 33 (FIG. 4B, FIG. 4C).

The inventor of the present application confirmed by the finite element analysis that the site of the diaphragm member 34 on which the stress concentrates is an outermost circumferential portion P11 of the contact range All during deformation of the diaphragm member 34 as above. In other words, when changing from the valve-open state to the valve-closed state, the stress concentration site in the diaphragm member 34 shifts according to changes of the contact range All, without being fixed. This prevents the diaphragm member 34 from breaking even when the valve element 32 repeats the contact and separation operations. Since the diaphragm member 34 is unlikely to break as above, the distance (the stroke amount) between the position of the valve element 32 in the valve-open state and the position of the valve element 32 in the valve-closed state can be increased than before. Such an increased stroke amount allows an increase in the distance between the valve element 32 and the valve seat 33 in the valve-open state, and hence the Cv value of the fluid control valve 1 increases.

Here, as shown in FIG. 4B and FIG. 4C, preferably, the radius of the convex spherical surface 94 is set to be 50% or more and 65% or less of the radius of the spherical surface 341 in order to allow the diaphragm member 34 to deform to follow the shape of the convex spherical surface 94. In the present embodiment, the radius (the first radius) of the convex spherical surface 94 is about 70 mm, and the radius (the second radius) of the facing surface 341 of the diaphragm member 34 is about 140 mm.

Furthermore, the diameter D11 of the first holding piece 93 is set as large as possible, so that a larger stroke amount can be ensured. Specifically, the diameter D11 of the first holding piece 93 (see FIG. 2) is preferably a value exceeding 35% of the diameter D21 of the diaphragm member 34 (see FIG. 3). The diameter D21 of the diaphragm member 34 is the diameter of the diaphragm member 34 when projected onto the plane perpendicular to the central axis CL of the operation rod 9, that is, the diameter of the rim portion 344 in the present embodiment.

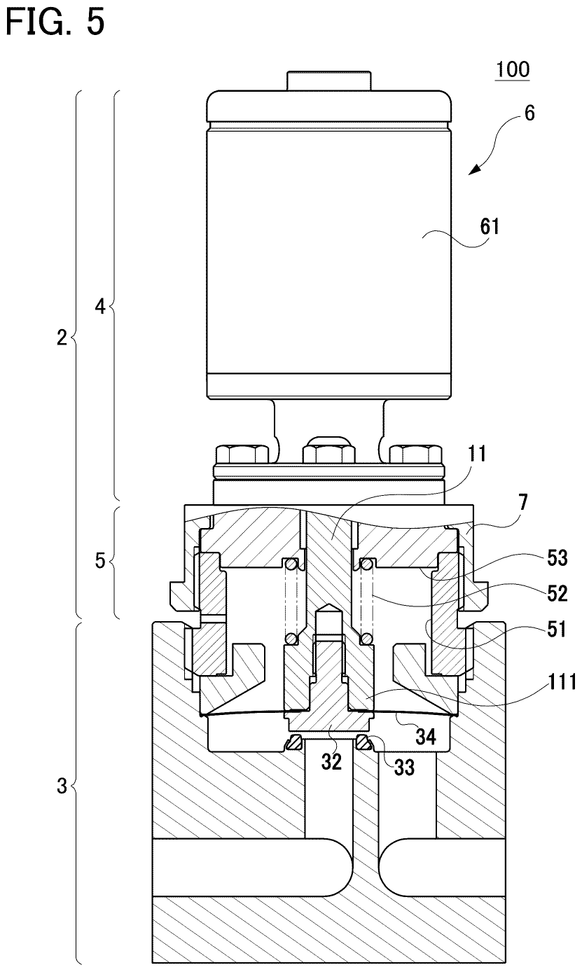

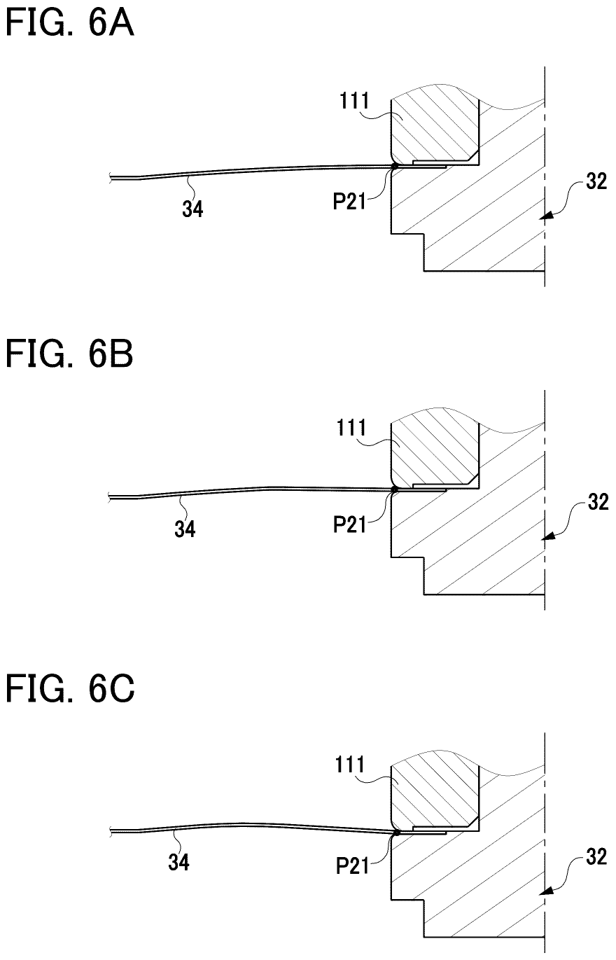

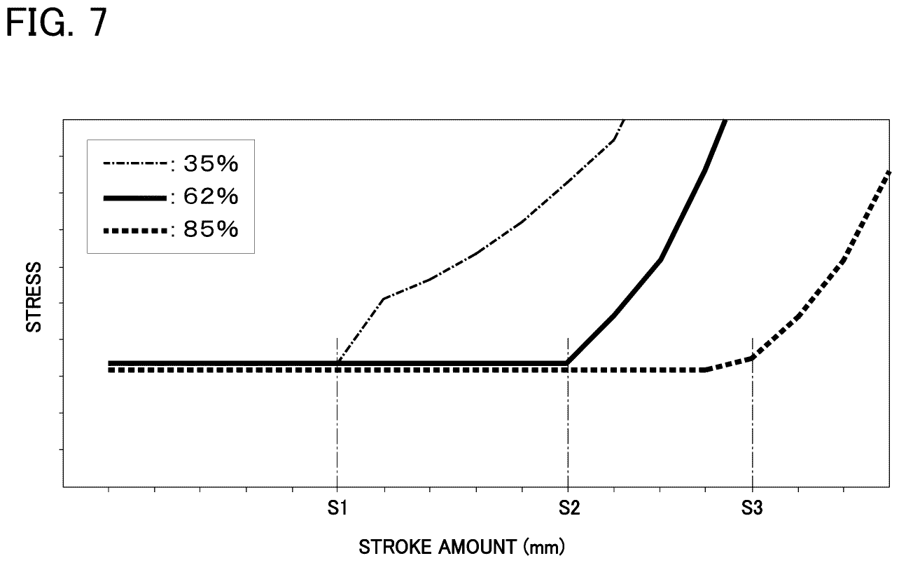

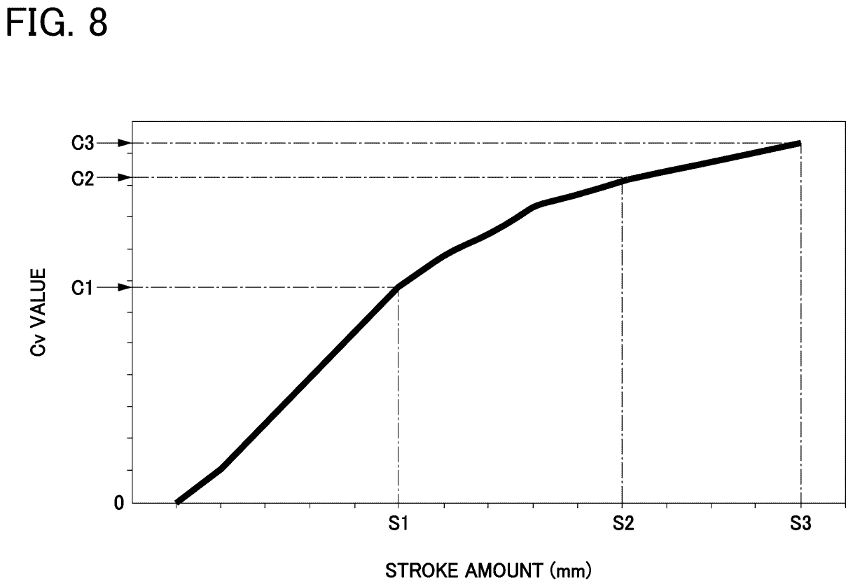

The above configuration will be specifically described, referring to FIG. 7 and FIG. 8. FIG. 7 is a graph showing the relationship between the moving amount (the stroke amount) of the valve element 32 from the position where the valve element 32 is in the valve-open state (hereinafter, a valve-open position) in the contact direction and the stress generated in the diaphragm member, and comparing different cases where the diameter D11 of the first holding piece 93 is set to 35% of the diameter D21 of the diaphragm member 34, 65% of the diameter D21, and 85% of the diameter D21. A waveform plotted by a dash-dotted line in FIG. 7 indicates the case where the diameter D11 is set to 35% of the diameter D21. This setting of the diameter D11 at 35% of the diameter D21 is the same as the relationship between the diameter of the holding portion 111 and the diameter of the diaphragm member 34 in the fluid control valve 100 shown in FIG. 5. A waveform plotted by a solid line in FIG. 7 indicates the case where the diameter D11 is set to 65% of the diameter D21. A waveform plotted by a broken line in FIG. 7 indicates the case where the diameter D11 is set to 85% of the diameter D21. A rising section of each waveform represents that stress concentration occurs to such an extent that the diaphragm member 34 is broken. FIG. 8 is a graph showing the relationship between the stroke amount of the valve element 32 and the Cv value under high temperatures. This shows that the larger the stroke amount, the greater the Cv value.

In the case where the diameter D11 of the first holding piece 93 is set to 35% of the diameter D21 of the diaphragm member 34, the waveform rises when the moving distance of the valve element 32 reaches S1 (see FIG. 7). This means that the stress concentration is generated to such an extent that the diaphragm member 34 is broken when the moving distance of the valve element 32 reaches S1. Thus, the stroke amount can be obtained up to a maximum of S1. When the stroke amount is S1, the Cv value of the fluid control valve 1 (the fluid control valve 100) is C1 (see FIG. 8).

For example, in the case where the diameter D11 of the first holding piece 93 is set to 65% of the diameter D21 of the diaphragm member 34 the waveform rises when the moving distance of the valve element 32 reaches S2 (see FIG. 7). This means that the stress concentration is generated to such an extent that the diaphragm member 34 is broken when the moving distance of the valve element 32 reaches S2. Thus, the stroke amount can be obtained up to a maximum of S2. This stroke amount is about 1.8 times the stroke amount that is ensured when the diameter D11 is 35% of the diameter D21. When the stroke amount is S2, the Cv value of the fluid control valve 1 is C2 (see FIG. 8). This is about 1.5 times the Cv value achieved when the diameter D11 is 35% of the diameter D21.

Furthermore, for example, in the case where the diameter D11 of the first holding piece 93 is set to about 85% of the diameter D21 of the diaphragm member 34, the waveform rises when the moving distance of the valve element 32 reaches S3 (see FIG. 7). This means that the stress is generated to such an extent that the diaphragm member 34 is broken when the moving distance of the valve element 32 reaches S3. Thus, the stroke amount can be obtained up to a maximum of S3. This stroke amount is about 2.5 times the stroke amount that is ensured when the diameter D11 is 35% of the diameter D21. When the stroke amount is S3, the Cv value of the fluid control valve 1 is C3 (see FIG. 8). This is about 1.6 times the Cv value achieved when the diameter D11 is 35% of the diameter D21.

When the diameter D11 of the first holding piece 93 is a value exceeding 35% of the diameter D21 of the diaphragm member 34, as described above, the rising of the waveform can be delayed as compared with the case where the diameter D11 is 35% of the diameter D21, as shown in FIG. 7. In other words, the valve element 32 can be moved more largely, i.e., the stroke amount can be increased. The diameter D11 of the first holding piece 93 is preferable to be as large as possible if feasible in the structure of the fluid control valve 1, but it is actually smaller than the diameter D21 of the diaphragm member 34.

(1) As described above, the fluid control valve 1 in the present embodiment is configured such that: the fluid control valve 1 includes the operation rod 9, the valve element 32 coupled to the operation rod 9, the valve seat 33 which the valve element 32 contacts and separates from, and the diaphragm member 34 located between the operation rod 9 and the valve element 32. The valve element 32 is to be driven by the operation rod 9 to contact and separate in the central axis CL of the operation rod 9 to control a control fluid. The diaphragm member 34 has a spherical cap shape having its center positioned on the extension line of the central axis CL and bulging toward the operation rod 9. The diaphragm member 34 is held, at its vertex portion (the cut edge 343), from both sides in the direction parallel to the central axis CL by the first holding piece 93 that contacts the diaphragm member 34 from the side of the operation rod 9 and the second holding piece 323 that contacts the diaphragm member 34 from the side of the valve element 32. The first holding piece 93 and the second holding piece 323 each have a circular shape located coaxially with the operation rod 9. The diameter D11 of the first holding piece 93 is larger than the diameter D of the second holding piece 323. The surface of the first holding piece 93, facing the diaphragm member 34, is the convex spherical surface 94 bulging toward the diaphragm member 34 and having the center on the central axis CL of the operation rod 9.

(2) In the fluid control valve 1 described in (1), preferably, the radius of the convex spherical surface 94, which is the first radius, is smaller than the radius of the spherical surface (the facing surface 341) of the diaphragm member 34 facing the convex spherical surface 94, which is the second radius.

(3) In the fluid control valve 1 described in (1), preferably, the first radius is between 50% and 65% inclusive of the second radius.

(4) In the fluid control valve 1 described in any one of (1) to (3), preferably, the diameter D11 of the first holding piece 93 is a value exceeding 35% of the diameter D21 of the diaphragm member 34 when projected onto the plane perpendicular to the central axis CL.

According to the fluid control valve 1 described above, when the valve element 32 moves to contact the valve seat 33, the diaphragm member 34 gradually deforms such that its vertex portion clamped between the first holding piece 93 and the second holding piece 323 is pushed down toward the valve seat 33. During this deformation, the diaphragm member 34 deforms to follow the shape of the convex spherical surface 94 of the first holding piece 93. Thus, the contact range All where the diaphragm member 34 contacts the convex spherical surface 94 gradually widens from the central portion of the diaphragm member 34 toward the outer circumferential side as the valve element 32 comes close to the valve seat 33. At that time, the stress on the diaphragm member 34 concentrates at the outermost circumferential portion P11 of the contact range All in the diaphragm member 34, which was confirmed by the inventor of the present application by the finite element analysis. In other words, when changing from the valve-open state to the valve-closed state, the site of stress concentration in the diaphragm member 34 shifts according to changes of the contact range All, without being fixed. This prevents the diaphragm member 34 from breaking even when the valve element 32 repeats the contact and separation motions. Since the diaphragm member 34 is unlikely to break as above, the distance (the stroke amount) between the position of the valve element 32 in the valve-open state and the position of the valve element 32 in the valve-closed state can be increased than before. Such an increased stroke amount allows an increase in the distance between the valve element 32 and the valve seat 33 in the valve-open state, and thus the Cv value of the fluid control valve 1 increases.

The foregoing embodiments are mere examples and give no limitation to the present invention. The present invention may be embodied in other specific forms without departing from the essential characteristics thereof. For example, the drive unit 2 of the fluid control valve 1 in the present embodiment is provided with the pneumatically-driven air cylinder 6 as a drive source, but may use for example an electrically-driven linear motor or other types of drive sources. In the present embodiment, furthermore, the first holding piece 93 and the operation rod 9 are integrally formed as a single component, but they may also be formed as separate components. Similarly, the second holding piece 323 and the valve element 32 are integrally formed as a single component, but they may also be formed as separate components.

### REFERENCE SIGNS LIST

1 Fluid control valve
9 Operation rod
32 Valve element
33 Valve seat
34 Diaphragm member
93 First holding piece
94 Convex spherical surface
323 Second holding piece

1. A fluid control valve comprising:
an operation rod;
a valve element coupled to the operation rod;
a valve seat which the valve element makes contact with and separation from; and
a diaphragm member located between the operation rod and the valve element,
the valve element being to be driven by the operation rod to make the contact with and separation in a direction of a central axis of the operation rod to control a control fluid,
wherein the diaphragm member has a spherical cap shape that is centered on an extension line of the central axis and bulges toward the operation rod, and the diaphragm member is held, at its vertex portion, from both sides in a direction parallel to the central axis by a first holding piece that contacts the diaphragm member from a side of the operation rod and a second holding piece that contacts the diaphragm member from a side of the valve element,
wherein the first holding piece and the second holding piece each have a circular shape located coaxially with the operation rod, and a diameter of the first holding piece is larger than a diameter of the second holding piece, and
wherein a surface of the first holding piece, facing the diaphragm member, is a convex spherical surface that bulges toward the diaphragm member and is centered on the central axis.

2. The fluid control valve according to claim 1, wherein a radius of the convex spherical surface, which is a first radius, is smaller than a radius of a spherical surface of the diaphragm member facing the convex spherical surface, which is a second radius.

3. The fluid control valve according to claim 2, wherein the first radius is 50% or more and 65% less of the second radius.

4. The fluid control valve according to claim 1, wherein the diameter of the first holding piece is a value exceeding 35% of a diameter of the diaphragm member when projected onto a plane perpendicular to the central axis.

5. The fluid control valve according to claim 2, wherein the diameter of the first holding piece is a value exceeding 35% of a diameter of the diaphragm member when projected onto a plane perpendicular to the central axis.

6. The fluid control valve according to claim 3, wherein the diameter of the first holding piece is a value exceeding 35% of a diameter of the diaphragm member when projected onto a plane perpendicular to the central axis.
